(19) United States
(12) Patent Application Publication
(10) Pub. No.: US 2012/0128371 A1
(43) Pub. Date: May 24, 2012

(54) COMMUNICATION SYSTEM AND METHOD

(75) Inventors: Garry Allan Einicke, Kenmore (AU); David William Hainsworth, Westlake Queensland (AU); Lance Gregory Munday, Moggill (AU)

(73) Assignee: Commonwealth Secientific and Industrial Research Organization, Campell (AU)

(21) Appl. No.: 13/321,401

(22) PCT Filed: May 28, 2010
(86) PCT No.: PCT/AU2010/000661

§ 371 Date: Feb. 3, 2012

(30) Foreign Application Priority Data
May 28, 2009 (AU) 2009902426

(51) Int. Cl. H04B 10/12

(52) U.S. Cl. 398/141

(57) ABSTRACT

A communication system including: a first communication device located in a first zone; a second communication device located in a second zone for generating an optical carrier signal; and at least one optical fibre connected to the first communication device for supplying power for operation of the first communication device and for supplying the optical carrier signal from said second zone, wherein the first communication device includes: a user interface for inputting information; and an optical modulator for modulating the optical carrier signal to include information input with said user interface and forwarding the modulated signal via the at least one optical fibre to the second communication device.

### FIELD

The present invention relates to a communication system and method.

### BACKGROUND

Communication devices are typically supplied with power from a local power supply and/or a transformer. However, in some applications, it is desirable for power to be supplied remotely. Such applications include low power or hazardous environments.

Examples of hazardous environments include coal mines, where combustible gases such as methane occur naturally, and in oil refineries, chemical plants, gas works, or any other places where a flammable gas or vapour may be present. Other hazardous environments include zones where explosives may be stored or where high powered transmitters may be operating. In such environments it is advisable or a requirement that safeguards be applied to electrical equipment to ensure that they are made intrinsically safe in order to prevent explosion or fire. One such safeguard is the operation of electrical equipment at low power levels to reduce the likelihood of generating a spark, and to comply with intrinsic safety standards.

One existing method of supplying power remotely to electrical equipment is via conductive cable, such as copper cable. The copper cable enables power to be supplied to the device from a power supply remote from the device. For example, in an underground mining application, a power supply or generator is located above ground and supplies power to one or more communication devices located underground. However, when supplying remote power to these communication devices, there is a design trade-off between the length of copper cable and the impedance of the cable. This design trade-off means that the maximum possible length of cable tends to be short, such as less than 500 metres. This is clearly problematic where it is desired to supply power over longer distances. Furthermore, such transmitting communication devices still require considerable amounts of power thus affecting the maximum distance possible between the power supply and the communication device, and the scope of applications.

It is therefore an object of the present invention to provide a communication system, method and device which overcome, or at least alleviate one or more disadvantages of the prior art.

### DESCRIPTION OF THE INVENTION

According to one aspect of the present invention there is provided a communication system including:
a first communication device located in a first zone;
a second communication device located in a second zone for generating an optical carrier signal; and
at least one optical fibre connected to the first communication device for supplying power for operation of the first communication device and for supplying the optical carrier signal from said second zone, wherein
the first communication device includes:
a user interface for inputting information; and
an optical modulator for modulating the optical carrier signal to include information input with said user interface and forwarding the modulated signal via the at least one optical fibre to the second communication device.

The inclusion of an optical modulator in the embodiment of the present invention reduces the power requirement of the first communication device and thereby alleviates the need for a relatively high power consuming optical transmitter.

It would be appreciated by those skilled in the art that supplying power over optical fibre to the first communication device may increase the distance between the first communication device and a power source and thus the distance between the first and second communication devices. In one embodiment, an optical power source supplies power via optical fibre cable to a photovoltaic converter associated with the first communication device to supply power to its various components, such as a receiver, transmitter, controller, and a display. However, these components, in particular the transmitter, require considerable amounts of power whereas the level of power able to be delivered over the optical fibre cable is typically very low, e.g. 50 mW per core over 500 metres. Consequently, the maximum possible length of fibre optic cable between the power supply and the device may be constrained. Furthermore, it would be appreciated by those skilled in the art that the high power consumption of the transmitting component of the device limits the potential scope of applications which may employ a power over optical fibre system.

In an embodiment, the first zone may be a hazardous zone and the second zone may be a non-hazardous zone. Alternatively, the first and second zones may be both within either the hazardous or non-hazardous zones. As would be appreciated by those skilled in the art, a hazardous zone is deemed such if it contains an explosive atmosphere, stored explosives, etc. In an example of a coal mine, airborne coal dust and combustible gases may form an explosive atmosphere below the surface of the mine which is thus deemed a hazardous zone. Electrical devices for use in such a hazardous zone must comply with an industry standard for intrinsic safety in order to minimise the risk of explosion. This standard ensures that any available electrical and thermal energy supplied and/or generated by electrical devices within the hazardous zone is low enough to prevent ignition of the explosive atmosphere. Electrical devices for use within such an environment must not cause an explosion by generating a spark in an internal component, such as a switch, brush, connector, etc, or by generating excessive heat, under both normal use and fault conditions. A person skilled in the art will appreciate that these electrical devices may be made intrinsically safe by including components such as current limiting resistors, diodes and fuses to prevent high temperatures under all conditions and/or by limiting power consumption of these devices.

The communication system may include at least one first communication device in the hazardous zone designed to receive power via optical fibre from a corresponding optical power source located in the non-hazardous zone, whereby each device may operate at a sufficiently low power to comply with standards for intrinsic safety whilst allowing a conveniently large distance between the power source and corresponding first communication device. Thus, allowing a conveniently large distance between the second communication device located in the non-hazardous zone and each first communication device in the hazardous zone.

In an embodiment, the communication system is used for communication in mines, in particular emergency communication, where users or personnel underground in a hazardous zone use the first communication devices to alert those personnel, using the second communication device, above the surface of the mine of an incident that occurred below. Typically, the personnel then implement their own resources and systems available to them to leave the mine. In this scenario, the first communication devices are used to co-ordinate all personnel underground to walk out in an emergency. Alternatively, the system may be used in an emergency to aid rescue of trapped personnel. For example, personnel trapped underground in the mine by a physical impediment, fire or injury, may require communication to support an emergency management team's underground navigation and rescue activities, especially where the personnel are trapped deep underground for long periods of time.

It will be appreciated by a person skilled in the art that the communication system may also be employed in non-hazardous zone applications, such as in an industrial environment where the first zone may be within a work area and the second zone may be within an administrative area. In this case, the system may enable greater distance between the first communication device, its optical power source and the second communication device. Further, or in the alternative, the system may be used as a communication system in a mining environment under non-emergency conditions, i.e. for all communications between the surface and underground.

In another embodiment, each first communication device may communicate with a protocol converter located in the second zone intermediate the second communication device and the first communication device. In preference, the protocol converter converts information from the optical modulator to network data and transmits the network data to the second zone. The protocol converter may also convert network data to communication data to be able to be received by the user interface. In an example, the network may be a local area network (LAN) and the data communicated over the LAN may be compatible with the Ethernet protocol for reliable data transfer and greater data throughput.

It will also be appreciated by those persons skilled in the art that the protocol converter may transmit data via a network switch, such as an Ethernet switch, which is located in the second zone. The switch may transmit and receive data from more than one protocol converter in communication with more than one respective first communication device. For example, in the mining application described above, multiple communication devices may be located underground to communicate information in an emergency to a receiving station located above ground via at least one network switch. In addition, it is envisaged that more than one first communication device may communicate to a single protocol converter and then to the network switch. In addition, in an emergency, the first communication device may be automated to communicate information with the second zone in response to an emergency event occurring, such as a fire or rock fall.

In an embodiment where the protocol converter and network switch in the second zone are in a hazardous zone, it is appreciated by those skilled in the art that all components within the hazardous zone should be intrinsically safe. For example, the protocol converter and network switch may include communication equipment which conform to IEEE standards, such as IEEE 802.3x Ethernet switches and IEEE 802.11x wireless access points. These may be mounted within flame-proof enclosures to provide intrinsic safety when employed in the hazardous zone. In addition, intrinsically safe IEEE 802.3x Ethernet switches and IEEE 802.11x wireless access points may be employed and, in one embodiment, it is envisaged that alternative arrangements may be implemented, such as communication from the protocol converter to the network switch may be wireless or communication from the protocol converter to the first communication device may be wireless, however the first communication device receives power via optical fibre and the optical modulator modulates an optical carrier signal to reduce the power requirements of the first communication device. It is also envisaged that the information from the protocol converter may be received at the user interface of the device by an optical receiver and optical fibre cable may then be employed for all communication and power requirements.

In another embodiment, the protocol converter may be adapted to transmit the optical carrier signal to the optical modulator of the communication device for modulation via the at least one optical fibre. In the above mining example, the protocol converter may be located underground intermediate the first and second communication devices to reduce the distance required for transmission of the carrier signal and the data to and from the first and second communication devices. In one embodiment, the carrier signal is generated at the protocol converter upon receipt of a signal from the second communication device.

In one embodiment, the at least one optical fibre includes at least two optical fibres, where one optical fibre is for supplying power to the first communication device and the other is for both supplying the optical carrier signal and for forwarding the modulated signal. In another embodiment, the system includes one optical fibre for supplying the optical carrier signal and a separate optical fibre for forwarding the modulated signal. Furthermore, in yet another embodiment, the system includes yet another separate optical fibre for supplying information to be received by the user interface of the first communication device. However, it is to be appreciated by those skilled in the art that the optical carrier signal may include information to be received by the user interface and that the number of optical fibres employed by the system may be affected by data transfer requirements. In the above case, the communication system includes four separate optical fibres connected to the first communication device.

In an embodiment, the user interface of the first communication device may include a means to input and receive text based information to reduce the amount of data required to be transmitted and received and to thereby reduce power consumption. Such a device may include features such as an LCD display for displaying the text based information and a keypad for inputting text based information. However, it is to be understood by a person skilled in the art that such a device may instead or additionally include a microphone and speaker for communicating voice information. For example, the user interface may be voice over Internet protocol (VoIP) telephone and/or have a keypad, LCD display, microphone and speaker, etc, to communicate information to the second zone. In this example, it is envisaged that additional power may be supplied by providing an intrinsically safe internal battery for the first communication device which may be trickle charged via optical fibre from the second zone. Alternatively, additional power may also be supplied by installing multiple optical fibre cores to supply power to the communication device.

In addition, it will also be appreciated that during mine emergency incidents, such as an underground fire or flood, in which the AC power supplies are switched off, a power supply having an internal uninterruptable power supply (UPS) may be used to sustain connected communication equipment for up to several hours. It will be appreciated by those skilled in the art that the UPS may be located on the surface of the mine and comprise solar charged batteries. In an embodiment, the optical power sources for the first communication devices may be arranged in the non-hazardous zone (either above or below ground) and may be connected to the UPS to ensure that the first communication devices receive power via optical fibre in an emergency. In addition, the use of optical sources to power first communication devices via optical fibre allows for deeper boreholes with longer fibre lengths, which could be employed in a wide range of situations such as in mountainous terrains.

Furthermore, it is envisaged that a ring topology or configuration may be implemented where a plurality of network switches are employed in the communication system and are connected to each other, and whereby some of the network switches are connected to the receiving station network switch. In this case, if a failure in a connecting cable or a switch occurs, a rapid spanning tree protocol (RSTP) can automatically reroute all communication traffic via the redundant paths. Furthermore, the network switches may be supplied power via dual power supplies to provide further redundancy.

According to another aspect of the present invention there is provided a method of communicating between a first zone and a second zone including:
providing a first communication device located in said first zone and a second communication device in said second zone;
providing at least one optical fibre connected to the first communication device for supplying power for operation of the first communication device and for supplying an optical carrier signal from said second zone;
inputting information via a user interface of said first communication device;
modulating said optical carrier signal to include information input with said user interface; and
forwarding the modulated signal via the at least one optical fibre to said second communication device.

According to another aspect of the present invention there is provided a first communication device for use in the above communication system including:
at least one optical fibre input for supplying power and for supplying an optical carrier signal;
a user interface, powered by the supplied power, for inputting information;
an optical modulator, powered by the supplied power, for modulating said optical carrier signal to include information input with said user interface; and
at least one optical fibre output for forwarding the modulated signal.

In one embodiment, the first communication device may also include one optical fibre input for supplying the optical carrier signal to the optical modulator and one separate optical fibre input for supplying information to the user interface of the first communication device. However, it is to be appreciated by those skilled in the art that one optical fibre input may receive both the optical carrier signal and information to be received by the user interface.

In another embodiment, the first communication device may include a battery for supplying supplementary power for operation of the communication device, particularly in an emergency. The battery may be trickle charged via the supplied power to the device from the one optical fibre input, or from a further optical fibre input, to maintain charge of the battery. In the second case, a further optical fibre may be employed to supply power to the battery.

### BRIEF DESCRIPTION OF THE DRAWINGS

In order that the invention be more clearly ascertained, embodiments will now be described, by way of example, with reference to the accompanying drawings, in which:

FIG. 1 is a schematic view of a communication system according to an embodiment of the present invention;

FIG. 2 is a schematic view of the communication system of FIG. 1 showing a first communication device communicating with a protocol converter for converting information from the communication device to network data;

FIG. 3 is a schematic view of the communication system of FIG. 2 showing more than one first communication device communicating via protocol converters to a common receiving station;

FIG. 4 is a flow chart of a method implemented by the system of FIG. 1 according to an embodiment of the present invention; and

FIG. 5 is a schematic view of a first communication device for use in the system of FIG. 1.

### DETAILED DESCRIPTION

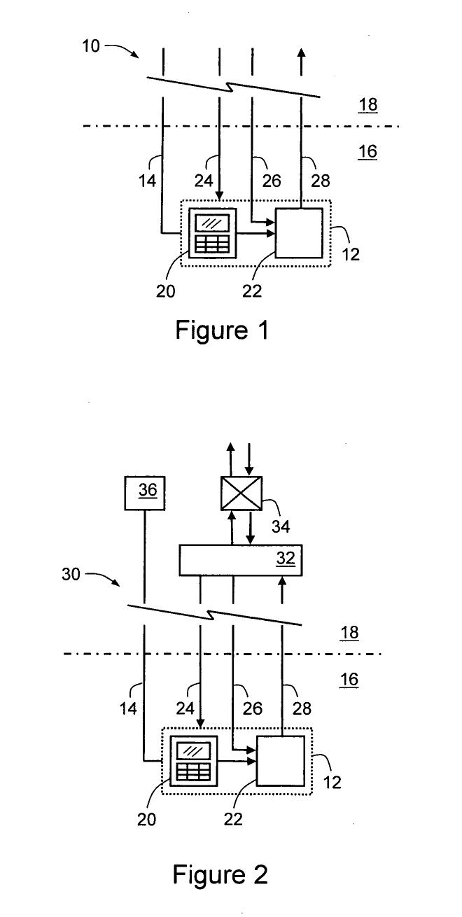

According to an embodiment of the present invention, there is provided a communication system 10 shown in FIG. 1 including at least one first communication device 12 adapted to receive power via optical fibre 14 and located in a first zone 16 for communication with a second zone 18. The system is employed in an underground coal mining application whereby the first zone is below the ground surface in a hazardous zone of the mine and the second zone is above ground in a non-hazardous zone.

The communication device 12 includes a user interface 20 to communicate information to a user (not shown) and an optical modulator 22 to modulate a received optical carrier signal 26 to include communication information from the user interface 20 and forward it to a second communication device in the second zone 18, i.e. above ground. The optical modulator 22 supports an intrinsically safe design because it reduces the power requirements of the device 12 and thereby the potential for explosion by alleviating the need for a relatively high power consuming optical transmitter component.

During operation of the communication system 10, a user (not shown) of the first communication device 12 in the first zone may communicate with a second communication device in the second zone 18, i.e. above the surface of a coal mine, by receiving an information signal 24 containing communication information, such as voice or text to be displayed to the user via the user interface 20, and the carrier signal 26. However, in order to further reduce the power and data transfer requirements of the device 12, text based communication is predominantly used for communication.

The optical modulator 22 modulates the optical carrier signal 26 received from the second zone 18 to include communication information from the user interface 20, typically in the form of text, but could be voice or video, and then forwards the modulated signal via optical fibre 28 to the second zone 18. The user interface 20 is shown to have a keypad and LCD display, but may also include a microphone and speaker to communicate information to the second zone 18. Also, the keypad is an alphanumeric keypad typically used with respect to mobile phone handsets.

The optical carrier signal 26 is generated in the second zone 18 to alleviate the need for a transmitter component in the first zone 16, or hazardous zone. Typically, a laser diode is pulsed to generate the carrier optical signal which is modulated to include information by an optical attenuator component of the optical modulator 22, which attenuates the received carrier signal in accordance with a desired modulation scheme corresponding to the communication information received from the user interface 20. The laser diode for generating the optical carrier signal may be incorporated into the second communication device in the second zone 18, or may be incorporated into an intermediate protocol converter 32 (shown in FIG. 2), which generates the signal upon receipt of a command from the communication device in the second zone 18.

An optical attenuator component of the modulator 22, such as an electrostatic micro-electro-mechanical system (MEMS) variable attenuator, can produce a 30 dB optical attenuation with a drive power of 2 mW. In contrast, a typical sized optical transmitter required to transmit such information would consume approximately 25 mW of power. In addition, an optical receiver component of the device 12 may consume around 10 mW, a microcontroller for the device around 5 mW, and an LCD display and keypad around 5 mW. Thus, a very low power consuming communication device may be designed to communicate information over long distances, especially from a hazardous zone, where it is desirable to have low power devices operating to comply with intrinsic safety standards.

In an embodiment shown in FIG. 2, each first communication device 12 in the communication system 30 may communicate information with a protocol converter 32 located in the second zone 18, intermediate the second communication device in the second zone 18 and each first communication device 12. The protocol converter 32 converts information from the modulated signal to network data and transmits the network data to personnel, or an automated monitoring service, in the second zone via a network switch 34. The protocol converter 32 also converts network data to communication information able to be received and displayed by the user interface 20 to a user. During operation, the user of the first communication device 12 may enter text based information into the user interface 20, which is converted to binary information for modulation onto the carrier signal and for conversion to network data by the protocol converter 32 which, in turn, transmits the text information to a user of the second communication device in the second zone.

The user interface 20 has low power circuits for low data rate communication, such as 4 kbits/s, and low power consumption so that it can receive power via optical fibre. The protocol converter 32 has high power circuits for high data rate communications, i.e. around 1 Gbit/sec. Thus, the protocol converter 32 may be powered via a separate power source to the first communication device 12. In a coal mine example, the protocol converter 32 may be located in the non-hazardous zone so that it may use higher powered components without needing to comply with intrinsic safety requirements. A skilled person would appreciate that having the protocol converter 32 operate the higher powered components required for suitable data communication to the second zone allows a further reduction in power consumption by the first communication device 12 and thus a further distance from which it may be powered by an optical source 36. It is envisaged that in some situations one optical power source 36 may be sufficient to supply power to more than one first communication device 12, via respective photovoltaic converters. However, as shown in FIG. 2, each first communication device 12 may be powered by its own optical power source 36, which is a laser diode located in the non-hazardous zone.

Furthermore, the protocol converter 32 in the non-hazardous zone may be adapted to include a laser diode or an optical fibre transmitter integrated circuit to generate and transmit the optical carrier signal 26 to the optical modulator 22 of the first communication device 12 thereby reducing the length of optical fibre required. Thus, all power and communication information transmitted into and out of the hazardous zone is via optical fibre, but communication and power transmission to and from the protocol converter 32, within the non-hazardous zone may be achieved via either copper wire or optical fibre cable.

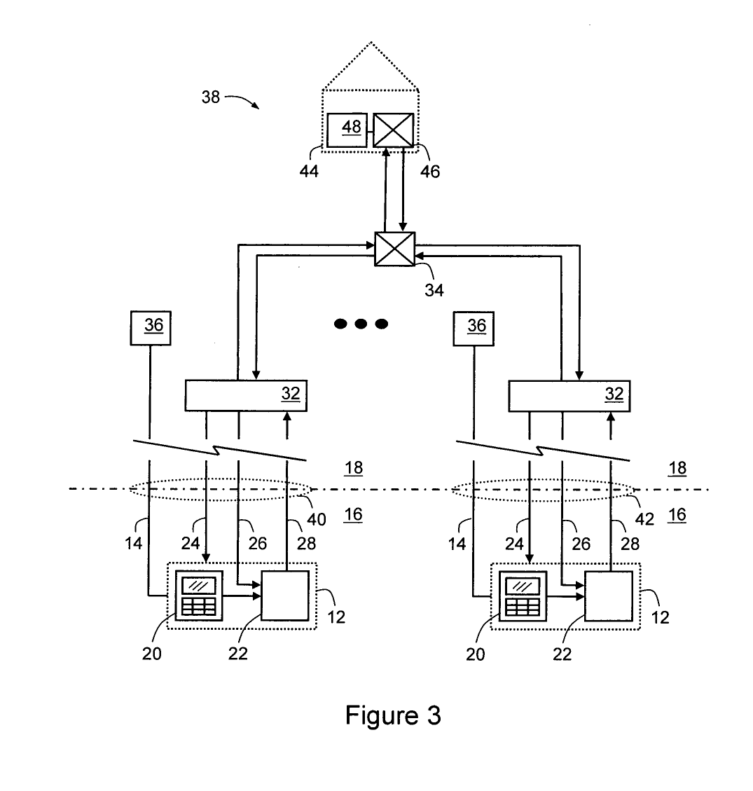

Referring now to FIG. 3, it can be seen that more than one first communication device 12 may be employed in a communication system 38 to communicate information from a first zone 16 to a second zone 18. In the coal mine example, more than one first communication device 12 is employed at desired intervals as communication devices located underground in the hazardous zone. In the example shown in FIG. 3, each first communication device 12 communicates via optical fibre through borehole 40 and borehole 42 to respective protocol converters 32 located in the second zone which, in turn, communicate to a network switch 34. The network switch 34 then communicates data to a receiving station 44, or a control room, via a receiving station switch 46 and ultimately to a second communication device 48 operable by a user or an automated system, such as a system to raise an alarm if a communication is received and a user is not present.

To ensure data reliability and greater data throughput, the network between the protocol converter 32 and the network switch 34 is a local area network (LAN) and use the Ethernet protocol. Thus, the network switch 34 is an Ethernet switch which can receive data from more than one protocol converter 32 and the receiving station network switch 46 is also an Ethernet switch which can communicate data with more than one network switch 34. Thus, the receiving station 44 may administer more than one system of communication devices 12. For example, the receiving station may monitor communication from first communication devices 12 distributed at regular intervals across more than one underground mine.

In the coal mine embodiment, the communication system 38 may be employed for both normal and emergency communication between users of the first communication devices 12 located underground in the hazardous zone 16 and a user of the second communication device 48 at the receiving station 44 located in the non-hazardous zone 18 above ground. The protocol converters 32, optical sources 36, network switches 34, etc, form communication node infrastructure, which may be supplied power from either underground or from the surface. In any event, when supplying power to the node infrastructure via conductive cable, consideration must be given to the output impedance of the supply which must be consistent with the impedance of the connecting cable and the input impedance of the load. Consideration may also be given to the difference between the supply output voltage and the voltage drop across the cable, which must be consistent with the minimum input voltage of the infrastructure equipment. Also, the maximum power supply to equipment distance is constrained by the acceptable cable voltage drop and the allowable inductance divided resistance (L/R). For example, suppose that it is desired to make a power supply to equipment distance arbitrarily long. In principle, increasing the cross-section surface area of the conductor will permit a longer cable. However, a longer cable will have increased inductance and eventually it will fail to meet the allowable L/R. However, the distance from a control room or receiving station 44 to a working face of an underground mine may be up to 10 km. Thus, in this example, the communication system 38 may be implemented using a combination of copper cable and optical fibre using a star or ring configuration, where the network switches 34 and protocol converters 32 are underground in the hazardous zone and made intrinsically safe. Furthermore, in order to reduce the distance from the optical source 36 to the corresponding first communication device 12, the optical source 36 could be made intrinsically safe and located in the hazardous zone.

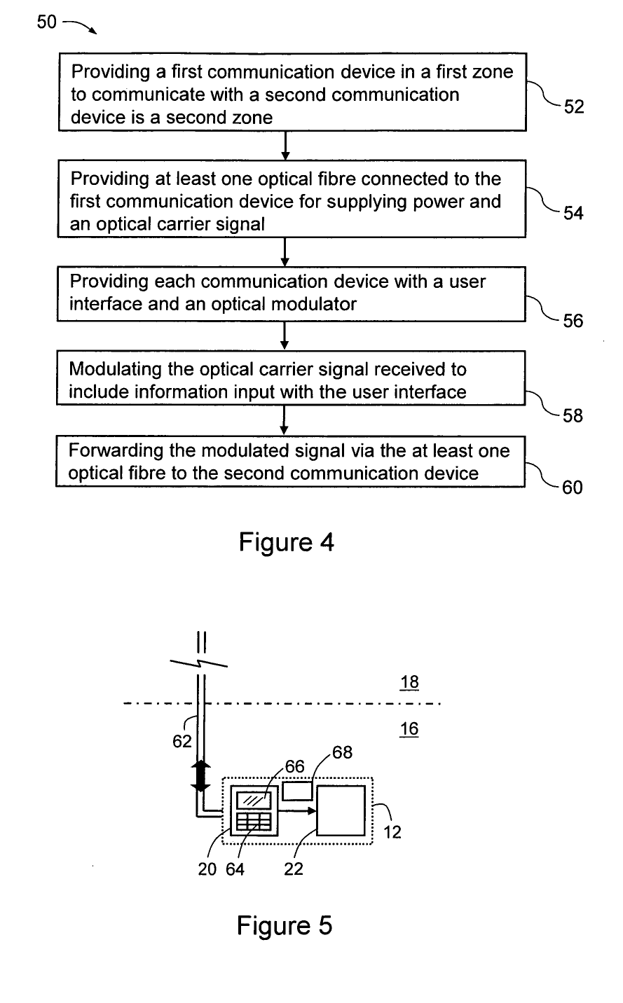

FIG. 4 is a summary of the method 50 of communicating between a first zone and a second zone by providing 52 a first communication device in the first zone to communicate with a second communication device in the second zone, providing 54 at least one optical fibre commented to the first communication device for supply of power using the above described power over optical fibre system, i.e. an optical source transmits an optical signal to a photovoltaic converter associated with each communication device to convert light energy to electrical energy for the device, and for supply of an optical carrier signal. The method 50 further includes providing the first communication device with a user interface and an optical modulator, modulating 58 the optical carrier signal to include communication information input with the user interface, and forwarding 60 the modulated signal via the at least one optical fibre to the second communication device.

FIG. 5 shows a first communication device 12 for use in a first zone 16 connected to a conduit 62 containing the optical fibres required for both power and communication with the second zone 18. The conduit 62 would be understood by those skilled in the art to house a multi fibre trunk cable, or optical fibre cable with multiple cores. Furthermore, the first communication device 12 includes optical fibre inputs that receive optical fibres from the conduit 62 and an optical fibre output to output or forward the modulated signal to the optical fibre. In one embodiment, the first communication device 12 includes separate inputs for supplying power to the device, including the user interface 20 and the modulator 22 components, and for supplying an optical carrier signal to the optical modulator 22. In addition, the device 12 includes a separate input for supplying information to be received by the user interface 20 of the first communication device 12.

The first communication device 12 shown in FIG. 5 is a text based device which communicates SMS or email based communication and the user interface 20 includes a keypad 64 and a display 66 to facilitate this. In this case, such a device requires less than 50 mW to operate, which is compatible with the power available from a single optical fibre core within a hazardous region. Thus, it would be appreciated by those skilled in the art that the conduit would house more than one optical fibre core for transmission of power and for communication of information, including transmission of the carrier signal and the modulated signal to and from the first communication device 12. Thus, the conduit may house at least four optical cores, one for power over fibre to the device 12, two for communication, and one for the optical carrier signal for optical modulation by the optical modulator 22.

The first communication device 12 also includes a battery 68 for supplying supplementary power for operation in the case of emergency or the need for additional power. In this case, the battery 68 is trickle charged using the supplied power to the first communication device 12.

It will be understood to persons skilled in the art of the invention that many modifications may be made without departing from the spirit and scope of the invention, in particular it will be apparent that certain features of the invention can be combined to form further embodiments.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “including” is used in an inclusive sense, i.e. to specify the presence of the stated features but not to preclude the presence or addition of further features in various embodiments of the invention.

1. A communication system including:
a first communication device located in a first zone; a second communication device located in a second zone for generating an optical carrier signal; and
at least one optical fibre connected to the first communication device for supplying power for operation of the first communication device and for supplying the optical carrier signal from said second zone, wherein
the first communication device includes:
a user interface for inputting information; and
an optical modulator for modulating the optical carrier signal to include information input with said user interface and forwarding the modulated signal via the at least one optical fibre to the second communication device, and wherein
the communication system include a protocol converter for communicating with the first communication device and located in the second zone intermediate the second communication device and the first communication device, the protocol converter converts information from said modulated signal to network data and transmits said network data to the second communication device.

2. A communication system as claimed in claim 1, wherein said protocol converter transmits said network data via a network switch to the second communication device.

3. A communication system as claimed in claim 2, wherein said protocol converter converts data received from said network switch to information to be received by the user interface of the first communication device and transmits said information to the user interface via the at least one optical fibre.

4. A communication system as claimed in claim 3, wherein said network switch transmits data and receives data from more than one protocol converter in communication with more than one respective first communication device.

5. A communication system as claimed in claim 1, wherein said protocol converter transmits said optical carrier signal to the optical modulator via the at least one optical fibre.

6. A communication system as claimed in claim 1, wherein said second communication device transmits said optical carrier signal to the optical modulator via the at least one optical fibre.

7. (canceled)

8. (canceled)

9. A communication system as claimed in claim 1, wherein the first zone is a hazardous zone and the second zone is a non-hazardous zone, and whereby the first communication device located in the first zone is intrinsically safe.

10. A communication system as claimed in claim 1, wherein the at least one optical fibre includes at least one optical fibre for supplying power to the first communication device and at least one optical fibre for supplying the optical carrier signal and for forwarding the modulated signal.

11. A communication system as claimed in claim 10, wherein the at least one optical fibre further includes at least one optical fibre for supplying the optical carrier signal and at least one separate optical fibre for forwarding the modulated signal.

12. A communication system as claimed in claim 11, wherein the at least one optical fibre further includes at least one separate optical fibre for supplying information to be received by the user interface of the first communication device.

13. A communication system as claimed in claim 1, wherein the optical carrier signal includes information to be received by the user interface of the first communication device.

14. A communication system as claimed in claim 1, further including at least one optical power source located in said second zone for supplying power to the first communication device via the at least one optical fibre.

15. (canceled)

16. A communication system as claimed in claim 1, wherein said user interface includes a display for displaying said text based information and a keypad for inputting said text based information.

17. A method of communicating between a first zone and a second zone including:
providing a first communication device located in said first zone and a second communication device in said second zone;
providing at least one optical fibre connected to the first communication device for supplying power for operation of the first communication device and for supplying an optical carrier signal from said second zone;
inputting information via a user interface of said first communication device;
modulating said optical carrier signal to include information input with said user interface;
forwarding the modulated signal via the at least one optical fibre to a protocol converter located intermediate said second communication device and the first communication device;
converting information from said modulated signal to network data; and
transmitting said network data to the second communication device.

18. A first communication device for use in a communication system of claim 1 including:
at least one optical fibre input for supplying power and for supplying an optical carrier signal;
a user interface, powered by the supplied power, for inputting information;
an optical modulator, powered by the supplied power, for modulating said optical carrier signal to include information input with said user interface; and
at least one optical fibre output for forwarding the modulated signal.

19. A first communication device as claimed in claim 18, wherein the at least one optical fibre input includes at least one optical fibre input for supplying power to operate the device and at least one separate optical fibre input for supplying the optical carrier signal.

20. A first communication device as claimed in claim 19, wherein the at least one optical fibre input further includes at least one optical fibre input for supplying information to be received by the user interface of the first communication device.

21. (canceled)

22. A first communication device as claimed in claim 18, wherein said user interface includes a display for displaying said text based information and a keypad for inputting said text based information.

23. A first communication device as claimed in claim 18, further including a battery for supplying supplementary power for operation of the first communication device.

24. A first communication device as claimed in claim 23, further including an optical fibre input for supplying power for trickle charging of said battery.

25. (canceled)
